(19) United States
(12) Patent Application Publication
(10) Pub. No.: US 2026/0326002 A1
(43) Pub. Date: Oct. 22, 2026

(54) FILTER INSERT AND VEHICLE AIR CONDITIONING FILTER COMPRISING A FILTER INSERT OF THIS TYPE

(71) Applicant: MAHLE Automotive Technologies (China) Co., Ltd., Shanghai (CN)

(72) Inventors: Danny Dai, Shanghai (CN); Jianhua Lei, Shanghai (CN); Rong Xie, Shanghai (CN)

(21) Appl. No.: 19/121,388

(22) PCT Filed: Oct. 27, 2023
(86) PCT No.: PCT/EP2023/080108

§ 371 Date: Apr. 15, 2025

(30) Foreign Application Priority Data
Nov. 1, 2022 (CN) 202222895301.8

(51) Int. Cl. B01D 39/20

(52) U.S. Cl. CPC B01D 39/2065; B01D 39/2058; B01D 2239/025; B01D 2239/0407; B01D 2239/0631; B01D 2239/0654; B01D 2239/10; B01D 2239/1233; B01D 2279/50

(57) ABSTRACT

The present application discloses a filter insert and a vehicle air conditioner filter with such a filter insert, and relates to the technical field of vehicle air conditioner filters. A filter insert that is used in a vehicle air conditioner filter includes a first filter layer, a second filter layer, a third filter layer, a layer of adsorbent material and a support layer, which are arranged sequentially one above the other in a direction from the gas inlet to the gas outlet. The third filter layer is a nanofiber layer. A nanofiber in the nanofiber layer has a diameter in the range of 10 nm to 800 nm and an adsorbent in the layer of adsorbent material includes an activated carbon. A vehicle air conditioner filter includes a filter body and an filter insert arranged in the filter body.

### FIELD OF THE DISCLOSURE

The present application belongs to the technical field of vehicle air conditioner filters and specifically relates to a filter insert and a vehicle air conditioner filter with such a filter insert.

### BACKGROUND

With constant advances in science and technology, vehicles can be found in many households. In recent years, in view of the environmental impact of emissions by motor vehicles and the increasing demands of people on air quality, increasingly stringent requirements have been placed on air quality in passenger compartments. Therefore, air that enters a vehicle must be treated to remove particles and harmful gases in incoming air. A vehicle air conditioner filter, also termed an air conditioner filter, can serve to filter the air entering the vehicle interior from outside and therefore increase the cleanliness of the air. General substances to be filtered out concern, inter alia, contaminants, microparticles, pollen, industrial exhaust gases and dusts that are contained in the air. The object of the air conditioner filter is to prevent the ingress of such substances into an air conditioning system and damage to the air conditioning system caused thereby, to create a good air environment for the occupants in the vehicle, to protect the physical health of the occupants in the vehicle, or to prevent fogging of the windows.

With regard to air purification through a vehicle air conditioning system, a filter insert of the air conditioner plays the most important role. With regard to the material structure of a conventional air conditioner filter insert, a plurality of layers of materials are arranged on top of each other. For example, the material structure along the direction from the gas inlet to the gas outlet sequentially comprises: a coarse filter layer, a fine filter layer, a gas absorption layer and a support layer. However, with regard to existing air conditioner filter inserts, there is the disadvantage that due to the changing and complicated environment in the practical use of a vehicle, the air conditioner filter insert is subjected to stresses of high and low temperatures and humidity as well as other environmental conditions before its replacement, thereby causing a weakening of the effect of the fine filter layer, which plays an important role in removing fine particles and has an electrostatic effect. Therefore, a large amount of PM 2.5 particles enters the cabin which endangers health.

If the density of the fine filter layer is increased significantly in order to lessen the reduction of the filtering effect due to weakening of the electrostatic absorption effect as a result of stress from the environment, this will, on the one hand, cause a significant increase in the ventilation resistance during filtering and, on the other hand, it is difficult to achieve a fiber diameter of less than 1 micrometer due to the limitation of the melt-blowing technique. If the electrostatic effect is eliminated, the effect of removing PM 2.5 is limited anyway. To alleviate the above problem, some solutions have been proposed in related technology. For example, Chinese Patent Publication No. CN 108619827 A discloses a nanofiber composite filter membrane that is provided with a nonwoven layer, a coarse filter layer and a nanofiber layer to prevent the ingress of PM 2.5 particles into a cabin. In practical application, however, experts found that a filter insert structure designed in this way or similarly has a sufficient service life in scenarios with high air quality, but with poorer air quality, the filter insert has a significantly different service life and filtering effect. Therefore, no effective solution is currently available in related technology.

### SUMMARY

The present utility model is based on the object of solving at least to some extent one of the above technical problems.

For this purpose, the present utility model proposes a filter insert that can be used in a vehicle air conditioner filter. This solves the problem that existing filter inserts are unable to effectively remove PM 2.5 or cannot achieve a desired filtering effect, long service life or sufficient stability.

The present utility model further proposes a vehicle air conditioner filter with an aforementioned filter insert. The vehicle air conditioner filter is characterized by high stability, a good filtering effect and a long service life and can remove both dust with large particles as well as PM 2.5 particles in the air.

To solve the aforementioned technical problem, the present application is constituted as follows:

According to one exemplary embodiment of the present utility model, a filter insert that is used in a vehicle air conditioner filter is provided, wherein the filter insert comprises: a first filter layer, a second filter layer, a third filter layer, a layer of adsorbent material and a support layer which are arranged sequentially one above the other in a direction from the gas inlet to the gas outlet;
wherein the third filter layer is a nanofiber layer, wherein a nanofiber in the nanofiber layer has a diameter in the range of 10 nm to 800 nm;
and wherein an adsorbent in the layer of adsorbent material comprises activated carbon.

The filter insert according to the exemplary embodiment of the utility model comprises the first filter layer, the second filter layer, the third filter layer, the layer of adsorbent material and the support layer. In this regard, the third filter layer is a nanofiber layer, and the fiber in the nanofiber layer has a diameter in the nanometer range. The ultra-thin fiber diameter ensures that even without electrostatic charges, the material can still maintain good filtering efficiency for dust particles in the micrometer and submicrometer range in the air. Accordingly, a good effect of the air conditioner filter insert for PM 2.5 particles is ensured throughout the entire life cycle. By arranging the first filter layer, the second filter layer and the nanofiber layer in coordination with each other, that is, the second filter layer is arranged downstream from the first filter layer with respect to the flow direction of the air and the nanofiber layer is arranged downstream from the second filter layer, passing coarse and fine particles can be further retained, which ensures that the nanometer fiber layer serves exclusively or in the long term to retain and absorb ultrafine particles. Accordingly, the filter insert has a simple structure and is convenient to use. With the arrangement of the above functional layers in coordination with each other, it is ensured that dust with large particles, PM 2.5 particles and harmful gases in the air are sequentially captured and filtered out so that the functions of the individual layers can be manifested as far as possible and unhindered. This improves the filtering effect, extends the service life and achieves good stability. Furthermore, the experience of use can be improved for the user.

Furthermore, the filter insert according to the present utility model can also have the following additional technical features:

In some embodiments, it is provided that a nanofiber in the nanofiber layer has a diameter in the range of 100 nm to 500 nm;
and/or that the nanofiber layer is produced using an electrostatic spinning technology.

In some embodiments, it is provided that the first filter layer is a filter layer made of coarse fibers, and the second filter layer is a filter layer made of fine fibers, wherein the diameters of fibers in the first filter layer, the second filter layer and the third filter layer are in descending order.

In some embodiments, it is provided that a fiber in the first filter layer has a diameter in the range of 8 μm to 50 μm;
and/or that a fiber in the second filter layer has a diameter in the range of 1 μm to 10 μm.

In some embodiments, it is provided that the activated carbon is a granular activated carbon;
or that the activated carbon is a fibrous activated carbon.

In some embodiments, it is provided that the layer of adsorbent material comprises a first layer of adsorbent material and a second layer of adsorbent material, wherein a granular activated carbon is used as the adsorbent in the first layer of adsorbent material, and a fibrous activated carbon is used as the adsorbent of the second layer of adsorbent material.

In some embodiments, it is provided that the first filter layer has a thickness of 0.2 mm to 2.5 mm;
and/or that the second filter layer has a thickness of 0.1 mm to 1.0 mm;
and/or that the third filter layer has a thickness of 0.001 mm to 0.1 mm;
and/or that the layer of adsorbent material has a thickness of 0.5 mm to 3 mm;
and/or that the support layer has a thickness of 0.1 mm to 2 mm.

According to one exemplary embodiment of the present utility model, a filter insert that is used in a vehicle air conditioner filter is further provided, wherein the filter insert comprises: a composite filter layer, a second filter layer, a third filter layer and a support layer which are arranged sequentially one above the other in a direction from the gas inlet to the gas outlet;
wherein the third filter layer is a nanofiber layer, wherein a nanofiber in the nanofiber layer has a diameter in the range of 10 nm to 800 nm;
and wherein the composite filter layer comprises a first filter layer and a layer of adsorbent material.

In some embodiments, it is provided that an adsorbent in the layer of adsorbent material comprises at least one of granular activated carbon and the fibrous activated carbon;
and/or that the first filter layer is a filter layer made of coarse fibers, and the second filter layer is a filter layer made of fine fibers, wherein the diameters of fibers in the first filter layer, the second filter layer and the third filter layer are in descending order.

According to one exemplary embodiment of the utility model, a vehicle air conditioner filter is provided. It comprises a filter body and an aforementioned filter insert which is arranged in the filter body.

The vehicle air conditioner filter according to the present utility model comprises the filter insert according to the above exemplary embodiments. Since the filter insert according to the exemplary embodiments of the utility model has the above advantageous effects, the corresponding advantageous effects for the vehicle air conditioner filter according to the present utility model can be achieved by providing the filter insert. That is, in the vehicle air conditioner filter according to the exemplary embodiment of the application, the first filter layer, the second filter layer, the third filter layer, the adsorbent material layer and the support layer are arranged in coordination with each other, and the third filter layer is formed as a nanofiber layer in which the ultra-thin fiber diameter ensures that even without electrostatic charges, the material can still maintain good filtering efficiency for the dust particles in the micrometer and submicrometer range in the air. Accordingly, a good effect of the air conditioner filter insert for PM 2.5 particles is ensured throughout the entire life cycle. By arranging the first filter layer, the second filter layer and the nanofiber layer in coordination with each other, that is, the second filter layer is arranged downstream from the first filter layer with respect to the flow direction of the air and the nanofiber layer is arranged downstream from the second filter layer, passing coarse and fine particles can be further retained, which ensures that the nanometer fiber layer serves exclusively or in the long term to retain and absorb ultrafine particles. Accordingly, the employed filter insert has a simple structure and is convenient to use. With the arrangement of the above functional layers in coordination with each other, it is ensured that dust with large particles, PM 2.5 particles and harmful gases in the air are sequentially captured and filtered out so that the functions of the individual layers can be manifested as far as possible and unhindered. This improves the filtering effect, extends the service life and achieves good stability. Furthermore, the experience of use can be improved for the user.

Other aspects and advantages of the present application will be set forth in the description below, and some of them will be clarified by the description below or experienced in practice within the scope of the utility model.

### BRIEF DESCRIPTION OF THE DRAWINGS

FIG. 1 shows a schematic structural view of a filter insert according to a first exemplary embodiment of the present application;

FIG. 2 shows another schematic structural view of the filter insert according to the first exemplary embodiment of the present application; and

FIG. 3 shows a schematic structural view of a filter insert according to a second exemplary embodiment of the present application.

### DETAILED DESCRIPTION

Hereinafter, the technical solutions of the exemplary embodiments of the application are fully and clearly explained with reference to the accompanying drawings in the exemplary embodiments of the application, wherein it is understood that the described exemplary embodiments represent a part of the exemplary embodiments rather than all of the exemplary embodiments. All other exemplary embodiments obtained by persons skilled in the art in this field from the exemplary embodiments of the application without inventive steps also fall within the scope of the application.

The exemplary embodiments of the application are discussed in more detail below with reference to the accompanying drawings based on the detailed exemplary embodiments and their application scenarios.

### First Exemplary Embodiment

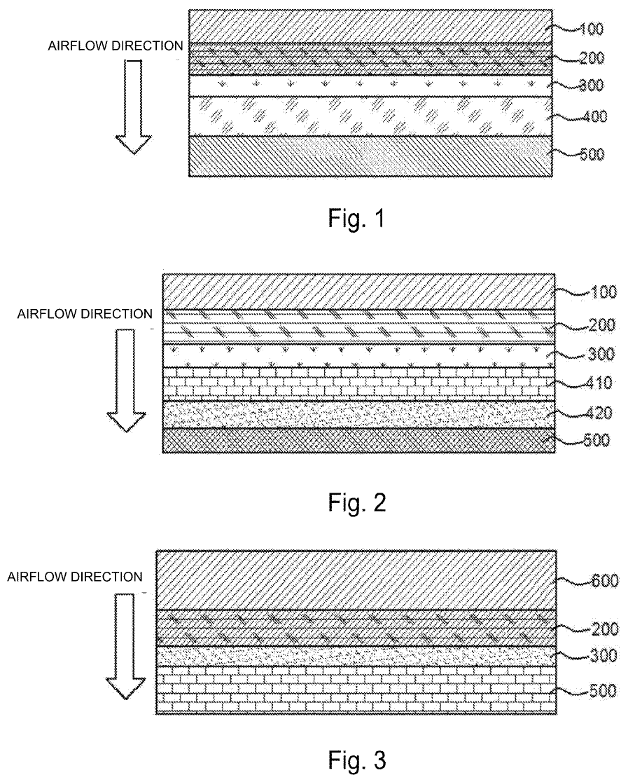

Reference is made to FIG. 1 to 2. In some exemplary embodiments, a filter insert is provided. It can be used with a vehicle air conditioner filter. As a filter insert in the filter, it serves to filter out dust particles, fine particles, PM 2.5 and harmful gases in the air to purify the air, achieve a desired filtering effect, and create a healthy and comfortable air environment.

In detail, the filter insert comprises the following: a first filter layer 100, a second filter layer 200, a third filter layer 300, a layer of adsorbent material 400 and a support layer 500 which are arranged sequentially one above the other along a direction from the gas inlet to the gas outlet and are connected to each other. For example, air flows from top to bottom, and the filter insert can comprise the first filter layer 100, the second filter layer 200, the third filter layer 300, the layer of adsorbent material 400 and the support layer 500 which are arranged sequentially from top to bottom, and the first filter layer 100, the second filter layer 200, the third filter layer 300, the layer of adsorbent material 400 and the support layer 500 are connected to each other.

According to the exemplary embodiment, the first filter layer 100 can serve to remove coarse particles from the air. For example, the first filter layer 100 can be made of coarse fibers having a diameter of several micrometers or a dozen micrometers to tens of micrometers. The second filter layer 200 can serve to remove particles in the micrometer and submicrometer range from the air. For example, the second filter layer 200 can be made of fine fibers with a relatively small diameter or, alternatively, a meltblown nonwoven fabric can be used. In particular, the third filter layer 300 is further provided in the filter insert, and the third filter layer 300 is a nanofiber layer. A nanofiber in the nanofiber layer has a diameter in the range of 10 nm to 800 nm. The nanofiber layer is made of fibers in the nanometer range and can serve to remove ultrafine particles, such as PM 2.5 particles, from the air. Furthermore, the nanofiber layer is arranged downstream from the first filter layer 100 and the second filter layer 200, which can ensure that the nanometer fiber layer serves exclusively or over the long term to retain and absorb ultrafine particles.

Adsorbent in the layer of adsorbent material 400 comprises activated carbon. The layer of adsorbent material 400 can serve to absorb harmful gases in the air. Adsorbent activated carbon can, for example, serve to absorb harmful gases or volatile organic compounds (VOCs) in the environment. The support layer 500 typically has good rigidity and 100, the second filter layer 200, the third filter layer 300 and the layer of adsorbent material 400 support and protect.

In a filter insert structure known in the prior art comprising a nanofiber layer, which still has the disadvantage of shortened service life or insufficient stability of the filter insert, the inventor of the present application found through numerous tests and comparisons under environments with different parameters that in related technology, a nanofiber layer is added to a filter paper of the filter insert to retain PM 2.5 particles by means of its densely arranged through-pores, but fine particles that are not filtered out by a coarse filter layer are also retained by the nanofiber layer. Such particles clog the nanofiber layer. When the ventilation pressure is increased, such particles are then pushed and penetrate the nanofiber layer, so that the nanofiber layer fails, which ultimately leads to the failure of the filter function for PM 2.5 particles. In view of the above insight into the prior art, in order to avoid this disadvantage, it is provided in the present exemplary embodiment that the first filter layer 100, the second filter layer 200 and the nanofiber layer are arranged in coordination with each other, that is, the second filter layer 200, for example a fine filter layer, is downstream from the first filter layer 100, for example a coarse filter layer, and the nanofiber layer 300, namely the nanofiber layer, is arranged downstream from the second filter layer 200. This allows for further retention of coarse and fine particles passing through, which ensures that the nanometer fiber layer serves exclusively or in the long term to retain and absorb ultrafine particles.

In the present exemplary embodiment, by arranging the first filter layer 100, the second filter layer 200, the third filter layer 300, the adsorbent material layer 400 and the support layer 500 in coordination with each other, the order of each layer ensures that dust with large particles, PM 2.5 particles and harmful gases in the air are sequentially captured and filtered out, so that the functions of the individual layer can be manifested as far as possible and unhindered. In addition, the ultra-thin fiber diameter in the nanofiber layer ensures that even without electrostatic charges, the material can still maintain good filtering efficiency for dust particles in the micrometer and submicrometer range in the air. Accordingly, a good effect of the air conditioner filter insert for PM 2.5 particles is ensured throughout the entire life cycle.

Accordingly, based on the above design, the filter insert has a simple structure and is convenient to use. This improves the filtering effect, enables effective cleaning of the air environment in the vehicle interior, extends the service life of the filter insert, and achieves good stability. Furthermore, the experience of use can be improved for the user.

The specific structure of the filter insert for a vehicle air conditioner filter is explained in more detail below.

As shown in FIG. 1 or 2, individual layers can optionally be connected together by thermocompression. Alternatively, individual layers can be connected together by sewing or gluing. It is understood that in other embodiments it is conceivable to connect individual layers to each other in other known ways. For example, the first filter layer 100, the second filter layer 200, the third filter layer 300, the layer of adsorbent material 400 and the support layer 500 can be connected to each other by thermocompression or gluing, which provides good processing and manufacturing convenience and a reliable structure and contributes to the increase in production efficiency.

In order to better remove ultrafine particles, such as PM 2.5 particles, from the air, the fiber diameter in the nanofiber layer should lie in a suitable range. In some exemplary embodiments, it is provided that a nanofiber in the nanofiber layer has a diameter in the range of 500 nm to 600 nm. In some exemplary embodiments, it is provided that a nanofiber in the nanofiber layer has a diameter in the range of 100 nm to 500 nm. In some exemplary embodiments, it is provided that a nanofiber in the nanofiber layer has a diameter in the range of 200 nm to 400 nm. For example, the diameter of a nanofiber in the nanofiber layer can lie at 10 nm, 50 nm, 80 nm, 100 nm, 200 nm, 300 nm, 400 nm, 500 nm, 600 nm, 700 nm, 800 nm, etc. Of course other values are also conceivable. In the exemplary embodiments of the present application, there are no specific restrictions in this regard as long as the technical demands can be met.

In that the diameter of the nanofiber in the nanofiber layer lies within the above ranges, the removal of PM 2.5 by the vehicle air conditioner filter insert is facilitated and contributes to maintaining good filtering efficiency and filtering effect.

In some exemplary embodiments, the nanofiber layer is made using an electrostatic spinning technology. The nanofiber layer supported by electrostatic spinning technology has a better filtering effect and increased filtration stability.

In the filter insert, a nanofiber layer is provided that is made of fibers with a diameter of 10 nm to 800 nm, in particular nanofibers with a diameter of 100 nm to 500 nm. The nanofiber layer can be made using electrostatic spinning technology. Accordingly, the ultra-thin fiber diameter ensures that even without electrostatic charges, the material can still maintain good filtering efficiency for dust particles in the micrometer and submicrometer range in the air. This ensures a good effect of the air conditioner filter insert for PM 2.5 particles throughout the entire life cycle.

In some exemplary embodiments, it is provided that the first filter layer 100 is a filter layer made of coarse fibers, and the second filter layer 200 is a filter layer made of fine fibers, wherein the diameters of fibers in the first filter layer 100, the second filter layer 200 and the third filter layer 300 are in descending order.

Since the particle size of PM 2.5 is significantly smaller than the particle sizes of dust and other particles in the air, arranging the layers in such an order ensures that contaminants with the largest particle size are removed from the air first, then relatively large contaminants are removed from the air, and finally contaminants with the smallest particle size are removed. This also helps ensure that each of the membranes can manifest its particular function as much as possible, thereby maximizing the overall performance of the vehicle air conditioner filter insert.

In some exemplary embodiments, the diameter of a fiber in the first filter layer 100, namely the filter layer of coarse fibers, is in the range of 8 μm to 50 μm. The diameter can further lie in the range of 8 μm to 30 μm, further in the range of 15 μm to 25 μm, and preferably lies at 18 μm. For example, the diameter of a fiber in the coarse fiber filter layer can lie at 8 μm, 10 μm, 15 μm, 18 μm, 20 μm, 25 μm, 30 μm, 50 μm, etc. Of course other values are also conceivable.

In some exemplary embodiments, the diameter of a fiber in the second filter layer 200, namely the filter layer of fine fibers, is in the range of 1 μm to 10 μm. The diameter can further lie in the range of 2 μm to 8 μm, further in the range of 3 μm to 7 μm, and preferably lies at 5 μm. For example, the diameter of a fiber in the fine fiber filter layer can lie at 1 μm, 2 μm, 3 μm, 4 μm, 5 μm, 6 μm, 7 μm, 8 μm, 10 μm, etc. Of course other values are also conceivable.

In that the diameters of fibers in the first filter layer 100, the second filter layer 200, and the third filter layer 300 are in descending order, and the first filter layer 100, the second filter layer 200, and the third filter layer 300 are each made from fibers having the above diameter ranges, the functions of the individual layers can be manifested, and contaminants of different dimensions or sizes can be more effectively filtered out sequentially, which increases the filtering efficiency and the filtering effect.

In some exemplary embodiments, the activated carbon is granular activated carbon, and the layer of adsorbent material 400 uses granular or powdered activated carbon fibers. Alternatively, in some exemplary embodiments, the activated carbon is fibrous activated carbon. That is, the layer of adsorbent material 400 is made of activated carbon fibers.

In the present exemplary embodiment, the layer of adsorbent material 400 is preferably made of activated carbon fibers. Compared with granular activated carbon, the porosity of activated carbon fiber can achieve a specific surface area in a larger range, lower filtration resistance, higher temperature, acid and alkali resistance, and better absorption capacity or higher absorption rate, in addition to the essential advantages of powdered molecular sieve, high resistance to detachment and good renewability. Furthermore, activated carbon fiber is characterized by good absorption effect for frequently encountered harmful gases (e.g. SO₂, H₂S, formaldehyde, etc.), in particular for volatile organic benzene compounds. By using fibrous activated carbon, the problem can be solved that existing granular activated carbon is not able to effectively absorb volatile organic substances.

Optionally, the fibrous activated carbon can be used without further ado. This means that unmodified fibrous activated carbon can be used. Alternatively, modified fibrous activated carbon can also be used. For example, fibrous activated carbon can inter alia be modified by oxidation or impregnation.

As can be seen from FIG. 2, in some exemplary embodiments, it can be provided that the layer of adsorbent material 400 comprises a first layer of adsorbent material 410 and a second layer of adsorbent material 420. Granular activated carbon is used as the adsorbent in the first layer of adsorbent material 410, and fibrous activated carbon is used as the adsorbent in the second layer of adsorbent material 420. That is, the first layer of adsorbent material 410 can be made of granular activated carbon, while the second layer of adsorbent material can be made of fibrous activated carbon. The layer of adsorbent material 400 can contain granular activated carbon and the fibrous activated carbon. That is, a combination of granular activated carbon and fibrous activated carbon is used to make the layer of adsorbent material 400.

The order in which the first layer of adsorbent material 410 and the second layer of adsorbent material 420 are arranged can be selected or determined according to actual need. For example, the filter insert comprises the first filter layer 100, the second filter layer 200, the third filter layer 300, the first layer of adsorbent material 410, the second layer of adsorbent material 420 and the support layer 500 which are arranged sequentially one above the other in the direction from the gas inlet to the gas outlet. Alternatively, the filter insert comprises the first filter layer 100, the second filter layer 200, the third filter layer 300, the second layer of adsorbent material 420, the first layer of adsorbent material 410 and the support layer 500, which are arranged sequentially one above the other in the direction from the gas inlet to the gas outlet.

In contrast to the design in the prior art in which the layer of adsorbent material is made exclusively of granular activated carbon, in the present exemplary embodiment, granular or powdered activated carbon is replaced or partially replaced by activated carbon fiber. Accordingly, fibrous activated carbon has lower ventilation resistance and smaller structural thickness than granular activated carbon with the same absorption capacity. The smaller thickness further reduces the ventilation resistance of the structure of the filter insert of pleated material.

Optionally, a nonwoven fabric or meltblown product can be used for the support layer 500. For example, the support layer 500 can be made from a meltblown PET or PP composite filter paper. Optionally, the support layer 500 can be, inter alia, a flat-layer membrane or a hollow fiber membrane.

In some exemplary embodiments, the thickness of a fiber in the first filter layer 100, namely the fiber filter layer of coarse fibers, lies in the range of 0.2 mm to 2.5 mm. The thickness can further lie in the range of 0.5 to 2 mm, further in the range of 0.8 mm to 1.5 mm, and preferably lies at 1 mm. Optionally, the first filter layer 100 has a weight in the range of 25 to 150 g/m². Furthermore, the weight can lie in the range from 40 to 120 g/m², further from 60 to 100 g/m². Preferably the weight lies at 80 g/m².

In some exemplary embodiments, the thickness of a fiber in the second filter layer 200, namely the fine fiber filter layer, lies in the range of 0.1 mm to 1.0 mm. The thickness can further lie in the range of 0.15 mm to 0.8 mm, further in the range of 0.2 mm to 0.5 mm, and preferably lies at 0.2 mm. Optionally, the second filter layer 200 has a weight in the range of 10 to 80 g/m². Furthermore, the weight can lie in the range from 15 to 60 g/m², further from 20 to 50 g/m². Preferably the weight lies at 25 g/m².

In some exemplary embodiments, the thickness of a fiber in the third filter layer 300, namely the nanofiber layer of coarse fibers, lies in the range of 0.001 mm to 0.1 mm. The thickness can further lie in the range of 0.002 mm to 0.08 mm, further in the range of 0.01 mm to 0.06 mm, and preferably lies at 0.05 mm. Optionally, the third filter layer 300 has a weight in the range of 2 to 15 g/m². Furthermore, the weight can lie in the range of 3 to 10 g/m². Preferably the weight lies at 3 g/m².

In some exemplary embodiments, the layer of adsorbent material 400 has a thickness in the range of 0.5 to 3 mm. Furthermore, the thickness can lie in the range of 0.8 to 2.8 mm, further from 1 to 2.5 mm. Preferably the thickness lies at 2 mm. Optionally, the layer of adsorbent material 400 has a weight in the range of 200 to 800 g/m². Furthermore, the weight can lie in the range of 300 to 700 g/m², further from 400 to 600 g/m². Preferably the weight lies at 500 g/m². Optionally, the layer of adsorbent material 400 is made of fibrous activated carbon. Alternatively, the layer of adsorbent material 400 consists of a combination of granular and fibrous activated carbon with a diameter lying in the range of 0.2 mm to 1 mm. Furthermore, the diameter can lie in the range of 0.25 mm to 0.8 mm, and further from 0.3 to 0.6 mm.

In some exemplary embodiments, the support layer 500 has a thickness in the range of 0.1 mm to 2 mm. Furthermore, the thickness lies in the range from 0.1 mm to 1 mm, further from 0.3 mm to 0.6 mm. Preferably the thickness lies at 0.5 mm. Optionally, the support layer 500 has a weight in the range of 50 to 100 g/m². Furthermore, the weight can lie in the range of 60 to 90 g/m², further from 70 to 80 g/m². Preferably the weight lies at 75 g/m². Optionally, it is conceivable that the diameter of a fiber in the support layer 500 lies in the range of 20 μm to 80 μm, further in the range of 25 μm to 50 μm, and further at 30 μm.

In that the first filter layer 100, the second filter layer 200, the third filter layer 300, the adsorbent material layer 400 and the support layer 500 have the thicknesses and weights in the above ranges, not only can contaminants of various size ranges in the air be filtered out and harmful gases be absorbed, but also high strength and structural stability and good ventilability can be achieved without increasing the air resistance of the filter insert. Furthermore, good processing and manufacturing convenience is achieved, and production using conventional processing technology is possible.

Optionally, the third filter layer 300, namely the nanofiber layer, can be manufactured by using a nonwoven fabric with a low gram weight (about 20 gsm) as a bearing layer on which the nanofiber layer is spun by means of the electrostatic spinning technique, after which the spun nanofiber layer and the bearing layer (support layer) are combined with other functional layers.

Optionally, the layer of adsorbent material 400 that is made of fibrous activated carbon can be made in detail as follows: by dispersing the activated carbon fiber (for example, with a diameter of 10 μm to 20 μm) in a dispersant (usually water with an auxiliary reagent), a uniformly dispersed suspension is formed. Water is separated from the suspension via a drainage mesh, and the activated carbon fiber forms a uniform fiber layer on the drainage mesh. The fiber layer is then dried through a drying process.

In some exemplary embodiments, a vehicle air conditioner filter is provided. It comprises a filter body and an aforementioned filter insert which is arranged in the filter body.

Optionally, the filter body can comprise a mounting frame that surrounds the perimeter of the filter insert. Optionally, a sealing structure can be provided on the outer side of the mounting frame.

It is understood that the filter body in the above vehicle air conditioner filter can comprise conventional components which are arranged in the mounting frame and the sealing structure. The specific structure and functional principle of the filter main body can be taken from the prior art, and there are no restrictions in this regard in the present exemplary embodiment. A detailed description thereof is not necessary here.

### Second Exemplary Embodiment

Reference is made to FIG. 3. In some exemplary embodiments, a filter insert that is usable in a vehicle air conditioner filter is provided, wherein the filter insert comprises: a composite filter layer 600, a second filter layer 200, a third filter layer 300, and a support layer 500 which are arranged sequentially one above the other in a direction from the gas inlet to the gas outlet.

The third filter layer 300 is a nanofiber layer, and a nanofiber in the nanofiber layer has a diameter in the range of 10 nm to 800 nm.

The composite filter layer 600 comprises a first filter layer 100 and a layer of adsorbent material 400.

The second exemplary embodiment is substantially the same as the first exemplary embodiment, and similar configurations will not be explained in more detail. For example, with respect to the specific materials, thicknesses and fiber diameter ranges of the first filter layer 100, the second filter layer 200, the third filter layer 300, the layer of adsorbent material 400 and the support layer 500, reference can be made to the description of the first exemplary embodiment. The second exemplary embodiment differs from the first exemplary embodiment primarily in the order or position in which the layer of adsorbent material 400 is arranged.

In the present exemplary embodiment, the composite filter layer 600 is formed by combining the layer of adsorbent material 400 and the first filter layer 100, after which the second filter layer 200 and the nanofiber layer are arranged sequentially downstream from the composite filter layer 600.

The layer of adsorbent material 400 is made of activated carbon fibers. Alternatively, a combination of granular activated carbon and fibrous activated carbon is used to make the layer of adsorbent material 400. In the present exemplary embodiment, by combining the first filter layer 100, namely the filter layer of coarse fibers, with the adsorbent material layer 400, the thickness of the entire material and the ventilation resistance of the material can be significantly reduced. Since the ventilation resistance of the structure of the filter insert of pleated material is also reduced due to the reduced thickness, better ventilability is achieved.

In some embodiments, it is provided that an adsorbent in the layer of adsorbent material 400 comprises at least one of granular activated carbon and the fibrous activated carbon. Preferably, the layer of adsorbent material 400 is made of fibrous activated carbon. Alternatively, the layer of adsorbent material 400 is made from a combination of granular and fibrous activated carbon.

In some exemplary embodiments, it is provided that the first filter layer 100 is a filter layer made of coarse fibers, and the second filter layer 200 is a filter layer made of fine fibers, wherein the diameters of fibers in the first filter layer 100, the second filter layer 200 and the third filter layer 300 are in descending order.

Optionally, the composite filter layer 600 (here, the layer of adsorbent material 400 is a layer of adsorbent material that is made of fibrous activated carbon) can be manufactured in detail as follows: activated carbon fibers are mixed with coarse fibers having a diameter of a dozen micrometers to dozens of micrometers, and a fluffy fiber net is manufactured by loosening, mixing, carding and laying after which the fiber net is solidified and molded by needling.

Content that is not further explained in the description of the present utility model belongs to the prior art which is generally known to persons skilled in the art.

So far, exemplary embodiments of the present application have been described with reference to the accompanying drawings. However, the present application is by no means limited to the above detailed exemplary embodiments. The above detailed exemplary embodiments are merely schematic and not limiting. Given the teaching of the present application, the average person skilled in the art in this field can make various modifications without departing from the basic concepts of the invention and the scope of protection claimed by the claims, all of which are within the scope of protection of the application.

The present application discloses a filter insert and a vehicle air conditioner filter with such a filter insert, and relates to the technical field of vehicle air conditioner filters. A filter insert is provided that is used in a vehicle air conditioner filter, wherein the filter insert comprises: a first filter layer, a second filter layer, a third filter layer, a layer of adsorbent material and a support layer, which are arranged sequentially one above the other in a direction from the gas inlet to the gas outlet; wherein the third filter layer is a nanofiber layer, wherein a nanofiber in the nanofiber layer has a diameter in the range of 10 nm to 800 nm; and wherein an adsorbent in the layer of adsorbent material comprises an activated carbon. A vehicle air conditioner filter is provided, wherein the vehicle air conditioner filter comprises a filter body and an aforementioned filter insert that is arranged in the filter body. The present application can solve the problem that existing filter inserts are unable to effectively remove PM 2.5 or cannot achieve a desired filtering effect, long service life or sufficient stability. Accordingly, the desired filtering effect can be achieved, and the experience of use can be improved for the user.

### LIST OF REFERENCE SIGNS

100—first filter layer;
200—second filter layer;
300—third filter layer;
400—layer of adsorbent material; 410—first layer of adsorbent material; 420—second layer of adsorbent material;
500—support layer;
600—composite filter layer.

1. A filter insert that is used in a vehicle air conditioner filter, the filter insert comprising:
a first filter layer,
a second filter layer,
a third filter layer,
a layer of adsorbent material, and
a support layer which are arranged sequentially one above the other in a direction from a gas inlet to a gas outlet;
wherein the third filter layer is a nanofiber layer, wherein a nanofiber in the nanofiber layer has a diameter in the range of 10 nm to 800 nm;
and wherein an adsorbent in the layer of adsorbent material comprises activated carbon.

2. The filter insert according to claim 1, wherein a nanofiber in the nanofiber layer has a diameter in the range of 100 nm to 500 nm.

3. The filter insert according to claim 1, wherein the first filter layer is a filter layer made of coarse fibers, and the second filter layer is a filter layer made of fine fibers, wherein the diameters of fibers in the first filter layer, the second filter layer, and the third filter layer are in descending order.

4. The filter insert according to claim 3, wherein a fiber in the first filter layer has a diameter in the range of 8 μm to 50 μm;

5. The filter insert according to claim 1, wherein the activated carbon is a granular activated carbon;
or the activated carbon is a fibrous activated carbon.

6. The filter insert according to claim 1, wherein the layer of adsorbent material comprises a first layer of adsorbent material and a second layer of adsorbent material, wherein a granular activated carbon is used as the adsorbent in the first layer of adsorbent material, and a fibrous activated carbon is used as the adsorbent of the second layer of adsorbent material.

7. The filter insert according to claim 1, wherein at least one of:
the first filter layer has a thickness of 0.2 mm to 2.5 mm;
the second filter layer has a thickness of 0.1 mm to 1.0 mm;
the third filter layer has a thickness of 0.001 mm to 0.1 mm;
the layer of adsorbent material has a thickness of 0.5 mm to 3 mm; or
the support layer has a thickness of 0.1 mm to 2 mm.

8. A filter insert that is used in a vehicle air conditioner filter, the filter insert comprises:
a composite filter layer,
a second filter layer,
a third filter layer, and
a support layer which are arranged sequentially one above the other in a direction from the gas inlet to the gas outlet;
wherein the third filter layer is a nanofiber layer, wherein a nanofiber in the nanofiber layer has a diameter in the range of 10 nm to 800 nm;
and wherein the composite filter layer comprises a first filter layer and a layer of adsorbent material.

9. The filter insert according to claim 8, wherein an adsorbent in the layer of adsorbent material comprises at least one of granular activated carbon and the fibrous activated carbon.

10. A vehicle air conditioner filter, characterized in that it comprises a filter body and a filter insert according to claim 1, which is arranged in the filter body.

11. The filter insert according to claim 1, wherein the nanofiber layer is produced using an electrostatic spinning technology.

12. The filter insert according to claim 2, wherein the nanofiber layer is produced using an electrostatic spinning technology.

13. The filter insert according to claim 3, wherein a fiber in the second filter layer has a diameter in the range of 1 μm to 10 μm.

14. The filter insert according to claim 4, wherein a fiber in the second filter layer has a diameter in the range of 1 μm to 10 μm.

15. The filter insert according to claim 8 wherein the first filter layer is a filter layer made of coarse fibers, and the second filter layer is a filter layer made of fine fibers, wherein the diameters of fibers in the first filter layer, the second filter layer and the third filter layer are in descending order.

16. The filter insert according to claim 9, wherein the first filter layer is a filter layer made of coarse fibers, and the second filter layer is a filter layer made of fine fibers, wherein the diameters of fibers in the first filter layer, the second filter layer and the third filter layer are in descending order.
